(19) United States
(12) Patent Application Publication
(10) Pub. No.: US 2014/0214308 A1
(43) Pub. Date: Jul. 31, 2014

(54) APPARATUS, SYSTEM AND METHOD FOR INCREASING BRAKING POWER

(71) Applicant: CUMMINS IP, INC., Columbus, IN (US)

(72) Inventors: John M. Mulloy, Columbus, IN (US); Daniel R. Dempsey, Indianapolis, IN (US); Ameya Oke, Franklin, IN (US)

(73) Assignee: CUMMINS IP, INC., Columbus, IN (US)

(21) Appl. No.: 14/162,486

(22) Filed: Jan. 23, 2014

Related U.S. Application Data
(60) Provisional application No. 61/758,154, filed on Jan. 29, 2013.

(51) Int. Cl. F02D 9/06

(52) U.S. Cl. CPC F02D 9/06
USPC 701/110

(57) ABSTRACT

Disclosed herein is an apparatus for increasing the braking power of a compression brake of an internal combustion engine having a variable geometry turbocharger. The apparatus includes an intake throttle module configured to close an air intake throttle in response to operation of the compression brake. Further, the apparatus includes a VGT module is configured to adjust a VGT component to decrease the swallowing capacity of the VGT in response to operation of the compression brake.

### CROSS-REFERENCE TO RELATED APPLICATION

This application claims the benefit of U.S. Provisional Patent Application No. 61/758,154, filed Jan. 29, 2013, which is incorporated herein by reference.

### FIELD

This disclosure relates to internal combustion engine braking systems, and more particularly relates to increasing compression braking power of an internal combustion engine.

### BACKGROUND

The improvement of fuel efficiency of an internal combustion engine is a primary concern of engine manufacturers, end users, and regulatory agencies. Many attempts have been aimed at improving the fuel efficiency of internal combustion engines. However, in many instances, such improvements to the fuel efficiency of an engine often come at the expense of one or more other performance characteristics of the engine. In other words, measures to improve the fuel efficiency of an internal combustion engine may place various operational and performance limitations on the engines.

Generally, the amount of fuel consumed by an engine, which is directly related to the fuel efficiency of the engine, is determined based on one or more predetermined control surfaces. Each control surface includes precalibrated values for the fuel injection and air handling systems for various engine speed and engine load combinations within the operating range of the engine. The operating range of the engine is also predetermined and is typically referred to as a torque-speed curve. The torque-speed curve constrains operation of the engine to a range of engine speed and engine load combinations. For example, the torque-speed curve may limit the maximum engine speed or load to improve fuel efficiency, among other reasons. Limiting the maximum engine speed or load of the engine is otherwise known as downspeeding the engine. For example, an engine can be downsped from a higher maximum allowable engine speed (e.g., 2,100 RPM) to a lower maximum allowable engine speed (e.g., 1,800 RPM).

Notwithstanding the potential improvements to the fuel efficiency of the engine by instituting speed and load limitations on the engine, other performance characteristics and/or operations may suffer or be correspondingly limited. For example, the compression braking power of a downsped engine may suffer because the engine is not allowed to reach the higher engine speeds that are particularly conducive to enhanced braking power. Further, downsped engine systems employ modified, recalibrated, or resized components that may be better suited for an engine with lower maximum speeds and loads. For example, for downsped internal combustion engine systems that include a turbocharger, often the components of the turbocharger (e.g., turbine and compressor) are smaller or have a lower capacity to accentuate the fuel efficiency of the downsped engine. Because lower capacity turbocharger components typically have lower limits on certain performance characteristics (e.g., maximum flow capacity for maximum rotor speed of the components), ability to utilize the turbocharger outside of the limits to improve compression braking power also was limited.

### SUMMARY

The subject matter of the present application has been developed in response to the present state of the art, and in particular, in response to the compression braking needs of internal combustion engines that have not yet been fully solved by currently available engine configurations. Accordingly, the subject matter of the present application has been developed to provide increased compression braking power in an internal combustion engine system.

Apparatuses, systems, and methods are disclosed for increasing the braking power of a compression brake of an internal combustion engine having a variable geometry turbocharger. A method also performs the functions of the apparatus.

According to one embodiment, an apparatus includes an intake throttle module configured to close an air intake throttle in response to operation of the compression brake. The apparatus may also include a variable geometry turbine (VGT) module configured to adjust a VGT component to decrease the swallowing capacity of the VGT in response to operation of the compression brake. In certain implementations, closing the air intake throttle includes completely closing the air intake throttle. In another implementation, closing the air intake throttle includes at least partially closing the air intake throttle based on a position of the VGT component.

In some implementations, the apparatus further includes an exhaust gas recirculation flow regulation device that increases an intake manifold pressure by recirculating exhaust gas to an intake manifold. In other implementations, the apparatus further includes an enablement module configured to determine whether enablement conditions are met. In some implementations, the VGT module adjusts the VGT component based on the enablement conditions.

In certain implementations, the enablement conditions are selected from the group consisting of a turbocharger speed less than a maximum turbocharger speed, an exhaust manifold pressure less than a maximum exhaust manifold pressure, and a compressor outlet temperature less than a maximum compressor outlet temperature. In other implementations, the VGT module decreases the swallowing capacity by closing a VGT component. In a further implementation, the VGT module adjusts the VGT component to maintain a speed of a compressor and increase in an exhaust manifold pressure.

In one embodiment, a method is disclosed that increases the braking power of a compression brake of an internal combustion engine having a variable geometry turbocharger. In one embodiment, the method includes determining if at least one enablement condition has been met. If the at least one enablement condition has been met, the method, in certain embodiment, includes reducing the swallowing capacity of the VGT, and at least one of closing an air intake throttle valve and opening an EGR flow regulation device.

In certain implementation, the enablement conditions are selected from the group consisting of a turbocharger speed less than a maximum turbocharger speed, an exhaust manifold pressure less than a maximum exhaust manifold pressure, and a compressor outlet temperature less than a maximum compressor outlet temperature. In some implementation, reducing the swallowing capacity of the VGT includes at least partially closing the VGT.

In certain implementation, opening an EGR flow regulation device increases a pressure in an intake manifold by recirculating exhaust gas to the intake manifold. In another implementation, determining includes determining if a turbocharger speed is less than a maximum turbocharger speed. In further implementations, the method further includes at least partially closing the VGT to increase the speed of the turbocharger.

In some implementation, the method further includes increasing a speed of compressor by at least partially closing a VGT component in the VGT in response to determining a compressor outlet temperature is less than a maximum compressor outlet temperature.

Disclosed herein is an internal combustion engine system. In one embodiment, the system includes an internal combustion engine that includes a compression brake. In another embodiment, the system includes an air intake throttle coupled in air providing communication with the internal combustion engine. In a further embodiment, the system includes a variable geometry turbocharger coupled in exhaust receiving communication with the internal combustion engine. In one embodiment, the system includes a controller configured to partially close the air intake throttle and partially close the variable geometry turbocharger during activation of the compression brake.

In certain implementations, the engine controller is further configured to open exhaust valves in combustion chambers of the internal combustion engine during a compression cycle of the combustion chambers. In some implementations, closing the air intake throttle includes at least partially closing the air intake throttle based on a position of an adjustable VGT component of the variable geometry turbocharger.

In certain implementations, the system further includes an intake manifold and an exhaust gas recirculation flow regulation device. In further implementations, the exhaust gas recirculation flow regulation device increases a pressure of the intake manifold by recirculating exhaust gas to the intake manifold. In some implementations, closing the VGT includes at least partially closing the VGT based on one or more enablement conditions.

According to some implementations, the enablement conditions are selected from the group consisting of a turbocharger speed less than a maximum turbocharger speed, an exhaust manifold pressure less than a maximum exhaust manifold pressure, and a compressor outlet temperature less than a maximum compressor outlet temperature. In some implementations, the controller is configured to increase a speed of a compressor by partially closing a VGT component in the VGT in response to the engine being downsped.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation.

In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 is an internal combustion engine in accordance with the present disclosure;

FIG. 2 is a schematic block diagram illustrating one embodiment of a controller in accordance with the present disclosure; and

FIG. 3 is a schematic flow chart diagram illustrating one embodiment of a method in accordance with the present disclosure.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

The subject matter of the present application has been developed in response to the present state of the art, and in particular, in response to the problems and needs in the internal combustion engine system art that have not yet been fully solved by currently available systems. Accordingly, in certain embodiments, a control system for an internal combustion engine is disclosed herein that improves the compression braking power of downsped internal combustion engines, particularly those equipped with components configured to match the lower speeds and loads of the engine. In other words, the control system and method described in the present disclosure overcomes many of the shortcomings of the prior art.

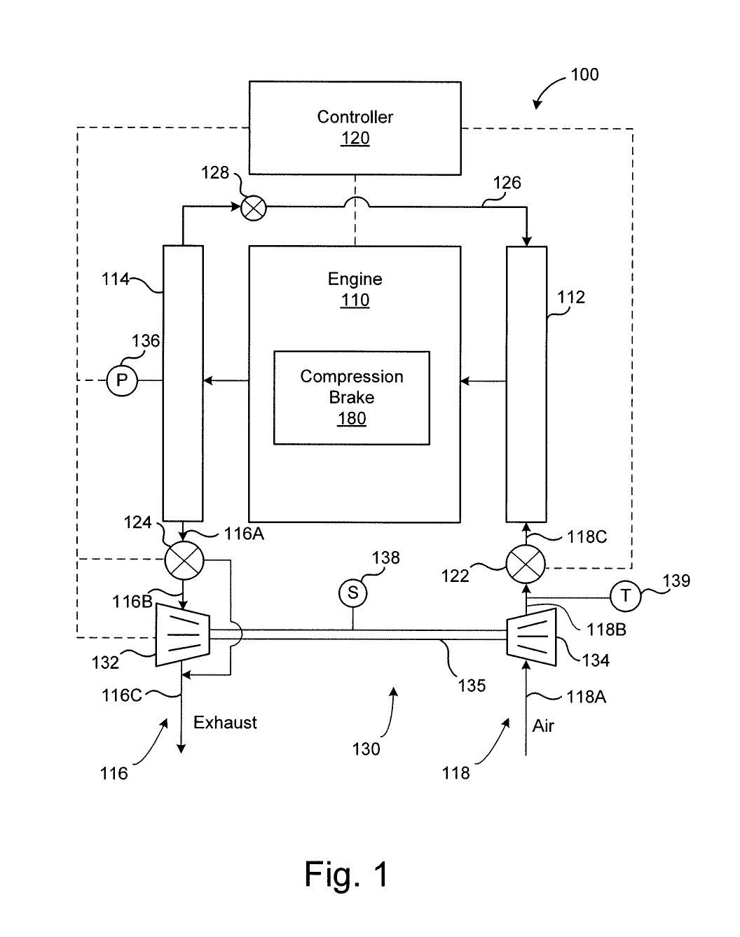

Referring to FIG. 1, according to one embodiment, an internal combustion engine system 100 includes an internal combustion engine 110 powered by a fuel. Although not shown, the engine system 100 may be placed within or form part of a vehicle and be configured to operate and propel the vehicle. The engine 110 may be a diesel-powered engine, a gasoline-powered engine, alternate-fuel-powered engine, or hybrid. The engine 110 generates power by combusting a fuel and air mixture within combustion chambers housed by the engine. The combustion of the mixture drives linearly-actuated or rotary-type pistons. The linear or rotational motion of the pistons rotates an engine output shaft that transfers power to a drivetrain (e.g., transmission) of a vehicle to move the vehicle. The amount of power generated by the engine 20 is largely dependent upon the quantity and timing of fuel added or injected into the combustion chambers. For example, the more fuel added to and combusted in the combustion chambers, generally the higher the power generated and fuel consumed by the engine. The quantity and timing of fuel added to the combustion chambers is dependent upon a variety of operating conditions, such as engine speed, engine load (e.g., demand), vehicle speed, air intake characteristics, pressure, and temperature.

The internal combustion engine 110 is coupled in air receiving communication with an air intake manifold 112 and in exhaust providing communication with an exhaust manifold 114. The air intake manifold 112 provides the air, and a fuel injector (not shown) provides the fuel, necessary for the combustion events in the combustion chambers. The air intake manifold 112 receives air from an air handling system, which includes a compressor 134 of a turbocharger 130, an intake throttle 122, and an air intake line 118. The compressor 134 can be any of various types of turbocharger compressors known in the art, such as fixed geometry compressors or variable geometry compressors. The compressor 134 includes a rotatable impeller that is configured to draw in and compress air from the first section 118A of the air intake line 118 as the impeller rotates. Generally, the compressor 134 converts a low pressure air stream into a high pressure air stream. The pressurization and retarding of the air stream also results in an increase in the temperature of the air stream.

The intake throttle 122 can be any of various flow regulating devices, such as a valve, orifice, and the like. Preferably, the intake throttle 122 is actively controlled by the controller 120 and can be actuated independently of the position of an accelerator pedal. The air intake line 118 includes a first section 118A upstream of the compressor 134, a second section 1188 between the compressor 134 and the intake throttle 122, and a third section 118C between the intake throttle and the air intake manifold 112. In some implementations, the air handling system includes a temperature sensor 139 coupled to the second section 118B of the air intake line 118. The temperature sensor 139 can be configured to measure the temperature of the air intake charge exiting the compressor 134. Alternatively, the temperature sensor 139 can be a virtual sensor configured to estimate the compressor outlet air temperature.

The exhaust manifold 114 receives the exhaust or combustion byproducts from the combustion events in the combustion chambers, and distributes the exhaust to an exhaust system. The exhaust system includes a turbine 132 of the turbocharger 130, an optional wastegate or bleed flow regulation device 124, and an exhaust line 116. The turbine 132 receives exhaust gas from the engine 110. The exhaust gas turns an impeller or wheel of the turbine 132 as the gas passes through the turbine 132 before exiting the exhaust system to the atmosphere. Generally, the speed and power of the engine 110 determines how fast the impeller turns because as the exhaust gas flow from the engine increases, the speed of the impeller likewise increases. However, the speed of the impeller can also be controlled by varying the geometry of the turbine 132. Accordingly, in one embodiment, the turbocharger 130 is a variable geometry turbocharger (VGT). Accordingly, the turbine 132 includes components that are selectively adjustable to vary the swallowing capacity of the turbine (e.g., the volume of exhaust gas that may be passed through the turbine housing at a given pressure ratio). The selectively adjustable components of the turbine 132 can include a slidable nozzle ring, moving shroud plate, and/or rotatable guide vanes. Also, as defined herein, the wastegate or bleed flow regulation device 124 can be considered a selectively adjustable component of the turbine 132 as it is actuatable to vary the volume and pressure of exhaust gas entering the turbine housing. The impeller of the turbine 132 is co-rotatably coupled to the impeller of the compressor 134 via a common shaft 135. Therefore, the impeller of the compressor 134 rotates at the same speed as the impeller of the turbine 132. In this manner, the exhaust gas drives the turbine 132, which in turn drives the compressor 134.

The flow regulation device 124 can be any of various flow regulating devices, such as a valve, orifice, and the like. Preferably, the device 124 is actively controlled. The exhaust line 116 includes a first section 116A between the exhaust manifold 114 and the wastegate flow regulation device 124, a second section 116B between the wastegate flow regulation device and the turbine 132, and a third section 116C downstream of the turbine 132 that vents to the atmosphere. In some implementations, the exhaust manifold 114 includes a pressure sensor 136. The pressure sensor 136 can be configured to measure the pressure of the exhaust gas in the exhaust manifold 114. Alternatively, the pressure sensor 136 can be a virtual sensor configured to estimate the exhaust pressure in the exhaust manifold 114. The engine system 100 may also include a physical or virtual speed sensor 138 configured to measure or estimate, respectively, the rotational speed of the turbine 132 and compressor 134.

In some embodiments, the engine system 100 includes an exhaust gas recirculation (EGR) line 126 coupling the intake manifold 112 in exhaust gas receiving communication with the exhaust manifold 114. Generally, the EGR line 126 facilitates the recirculation of exhaust gas (e.g., from the exhaust manifold 114) back to the engine 110 (e.g., the intake manifold 112) to alter the combustion characteristics of the engine (e.g., to decrease combustion temperatures and reduce nitrogen-oxide emissions). The flow of exhaust gas through the EGR line 126 can be regulated by an EGR flow regulation device 128 in the EGR line. The EGR flow regulation device 128 can be any of various flow regulating devices, such as a valve, orifice, and the like. Preferably, the device 128 is actively controlled. The position and configuration of EGR line 126 and EGR flow regulation device 128 is merely one implementation. In other implementations, the engine system 100 can have any of various configurations and types of EGR systems.

The engine 110 includes an internal compression brake 180 for decelerating the speed of, or braking, the engine to induce a slowing down of a vehicle in which the engine is installed. When activated (e.g., during a braking operation of the vehicle), the compression brake 180 opens an exhaust valve in the combustion chambers of the engine during the compression cycle to release compressed air in the chambers. In other words, the compression stroke of the engine pushes at least a portion of the compressed air out of the cylinder through the open exhaust valve and into the exhaust line of the engine. Because the compressed air is released through the open exhaust valve, the compressed air is prevented from pushing back on (e.g., accelerating) the descending piston after the compression stroke. Without the accelerating effect on the piston, the work performed during the compression stroke is not negated and the vehicle slows down due to a net decrease in the rotational speed of the crankshaft. The deceleration of the engine effectuated by the compression brake 180 can be expressed in terms of braking power.

As mentioned, the compression brake 180 is activated only when desired, such as when compression brake functionality is enabled and slowing down of the vehicle is desired (e.g., when an operator engages a brake pedal of a vehicle). Activation of the compression brake 180 can be facilitated by a compression brake demand 154 generated by a compression brake controller. The compression brake demand 154 is converted to an actuator command received by the functional units of the compression brake 180, which actuate according to the command to operate the compression brake as desired.

Although not shown, the engine system 100 can include other components. For example, the engine system 100 may include additional sensors to detect or estimate any of various operating conditions of the system. Also, the air handling system of the engine system 100 can include other components, such as an EGR system, and the exhaust system can include other components, such as exhaust emissions treatment devices.

The compression brake 180 can be activated at any of various speeds of the engine 110. However, the braking power generated by activation of the compression brake 180 is higher at higher engine speeds. Accordingly, in some embodiments, increasing (e.g., maximizing) the engine speed during activation of the compression brake 180 may be desirable. But, as discussed above, a downsped engine inherently has a lower maximum engine speed. For this reason, the braking power generated by the compression brake 180 in downsped engines is inherently lower without controls, extraneous to engine speed controls, configured to increase the braking power. The engine system 100 of the present disclosure employs such extraneous controls to increase the braking power of the compression brake 180 without exceeding the imposed engine speed limits.

Compression braking power is also dependent on the mass flow of air through the engine 110 and the pressure differential between the exhaust manifold 114 and the intake manifold 112 (e.g., across the engine 110). Generally, the higher the mass flow of air through the engine 110, the higher the compression braking power. Similarly, the higher the pressure differential between the exhaust manifold 114 and the intake manifold 112, the higher the compression braking power. The mass flow of air can be increased by increasing the engine speed or increasing the capacity of the compressor 134. Due to the above-discussed limits on engine speed and compressor capacity induced by downspeeding an engine, the ability to increase the mass flow of air to improve braking power also is limited. However, as will be described below, the engine system 100 includes controls to manipulate (e.g., increase) the pressure differential across the engine 110 without exceeding the limits imposed on engine speed and mass flow of air.

The controls of the internal combustion engine system 100 are controlled and operated by a controller 120 that, in one embodiment, communicates with and/or receives communication from various components of the engine system, including the engine 110, intake throttle 122, VGT components of the turbine 132 (which can include one or more of an adjustable nozzle ring, adjustable shroud plate, an adjustable impeller guide vane, and the wastegate flow regulation device 124), EGR flow regulation device 128, and the sensors 136, 138, 139. Generally, the controller 120 controls the operation of the engine system 100 and associated components. The controller 120 is depicted in FIG. 1 as a single physical unit, but can include two or more physically separated units or components in some embodiments if desired. In certain embodiments, the controller 120 receives multiple inputs, processes the inputs, and transmits multiple outputs. The multiple inputs may include sensed measurements or estimates from the sensors and various user inputs. The inputs are processed by the controller 120 using various algorithms, stored data, and other inputs to update the stored data and/or generate output values. The generated output values and/or commands are transmitted to other components of the controller and/or to one or more functional units of the engine system 100 to control the system to achieve desired results, and more specifically, achieve improved engine braking power. Many of the functional units of the system 100, such as the electronics and motors that actuate the VGT components of the turbine 132 and flow regulating devices, are omitted for clarity.

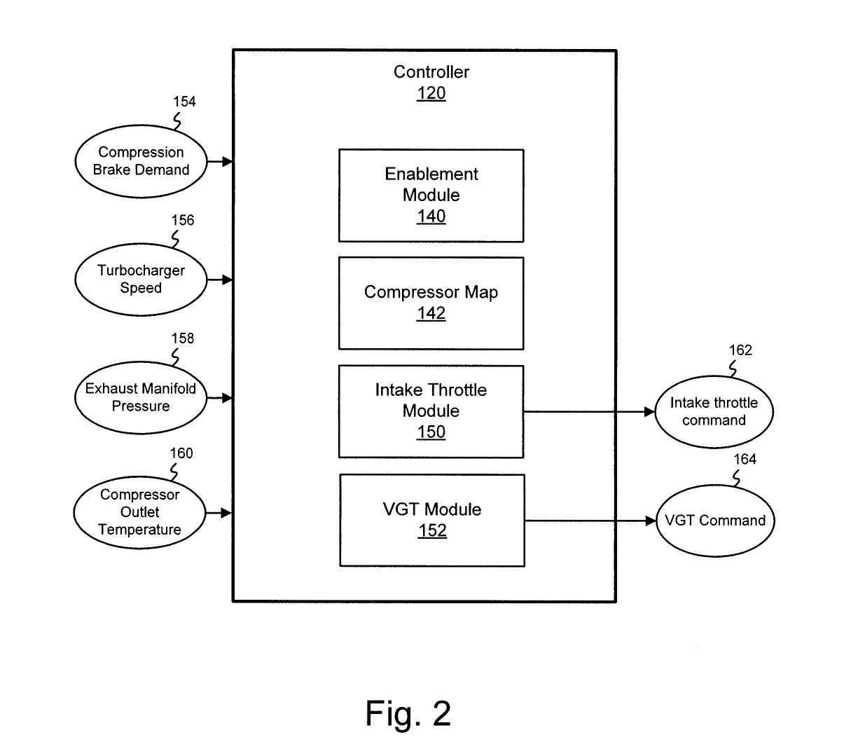

The controller 120 includes various modules and stores information for controlling the operation of the engine system 100. For example, as shown in FIG. 2 the controller 120 includes an enablement module 140, an intake throttle module 150, and a VGT module 152. Additionally, the controller 120 includes a compressor map 142 or control surface having predetermined speed values associated with various compressor pressure ratio and mass flow combinations for controlling the speed of the compressor 134. The intake throttle module 150 is configured to generate an intake throttle command 162 for actuating the intake throttle 122 based on the compression brake demand 154. Correspondingly, the VGT module 152 is configured to generate a VGT command 164 for actuating the VGT component of the turbine 132 also based on a compression brake demand 154. Generally, in one implementation, the intake throttle command 162 closes the intake throttle 122 and the VGT command 164 reduces the swallowing capacity of the turbine 132 when enablement conditions are met and activation of the compression brake 180 is desired.

Additionally, the controller 120 may include one or more modules for controlling actuation of the EGR flow regulation device 128 by generating an EGR command that modulates (e.g., increases) the flow of exhaust gas into the air intake manifold 112 to help produce, along with operation of the intake throttle and VGT component, operating conditions that enhance the braking power of the compression brake 180. In yet some embodiments, such an engine systems that do not include an intake throttle, the generated EGR command, in combination with operation of the VGT, the may help produce operating conditions that enhance the braking power of the compression brake 180. Accordingly, cooperatively providing EGR control (e.g., opening the EGR flow regulation device 128) along with VGT component control, the braking power of a compression brake (e.g., in an engine system that does not include an intake throttle) can be increased. In this manner, closing the intake throttle to improve braking power in one embodiment is effectively replaced with opening an EGR flow regulation device to improve braking power in another embodiment.

The enablement module 140 determines whether enablement conditions are met for the implementation of the braking power increase controls of the intake throttle module 150 and VGT module 152. Generally, the enablement module 140 receives operating conditions of the engine system 100 and compares the operating conditions with corresponding thresholds. The thresholds can be predetermined, static thresholds, or dynamic thresholds. In the illustrated embodiment, the operating conditions include a turbocharger speed 156 as determined (e.g., sensed or estimated) by the speed sensor 138, an exhaust manifold pressure 158 as determined by the pressure sensor 138, and a compressor outlet temperature 160 as determined by the temperature sensor 139. The enablement module 140 compares the turbocharger speed 156 to a maximum turbocharger speed threshold, compares the exhaust manifold pressure 158 to a maximum exhaust manifold pressure threshold, and compares the compressor outlet temperature 160 to a maximum compressor outlet temperature threshold. According to the desired implementation, if one, two, or all of the turbocharger speed 156, exhaust manifold pressure 158, and compressor outlet temperature 160 are less than the maximum turbocharger speed threshold, maximum exhaust manifold pressure threshold, and the maximum compressor outlet temperature threshold, respectively, then the enablement conditions for activating the braking power increase controls are met.

Although three enablement conditions are described in connection with the illustrated embodiment, in other embodiments, fewer or more enablement conditions can be utilized as desired. For example, in some embodiments, the enablement conditions may require that the turbocharger speed 156 is approximately equal to the maximum turbocharger speed threshold before the braking power increase controls are activated.

If the enablement conditions are met, as determined by the enablement module 140, and the compression brake demand 154 indicates compression braking is activated and demanded (e.g., a braking event or operation of the compression brake is occurring), then the intake throttle module 150 issues the intake throttle command 162 to close the intake throttle 122. The intake throttle command 162 may command a partial closing of the intake throttle 122 depending on the position of the VGT component(s). Closing the intake throttle 122 results in a drop in the air mass flow into the intake manifold 112, a drop in the pressure of the intake manifold 112 (e.g., drop in compressor pressure ratio), and a reduction in the speed of the turbocharger 130 (e.g., impellers of the turbine 132 and compressor 134).

Desirably, however, according to the compressor map 142, the intake manifold air mass flow, intake manifold pressure, and the turbocharger speed should not be dropped, and should be maintained at or near the maximum allowable rotor speed. Accordingly, if the enablement conditions are met, as determined by the enablement module 140, and the compression brake demand 154 indicates compression braking is activated and demanded, then the VGT module 152 issues the VGT command 164 to actuate the VGT components to reduce the swallowing capacity of the turbine 132. In one embodiment, the VGT component is an adjustable nozzle ring, adjustable shroud plate, and/or adjustable vane guides, and the VGT command 164 effectively closes the nozzle ring, shroud plate, and/or guides vanes to reduce the swallowing capacity. In another embodiment, additionally or alternatively, the VGT component is the wastegate flow regulation device 124, and the VGT command 164 closes the device to reduce the swallowing capacity of the turbine.

Reducing the swallowing capacity of the turbine 132 supplies the work required to increase the turbocharger speed, increase the intake manifold pressure, and increase the intake manifold air mass flow to levels at or near the levels before the intake throttle 122 was closed as dictated by the compressor map 142. Additionally, reducing the swallowing capacity of the turbine 132 by adjusting the VGT components results in an increase in the exhaust manifold pressure. Because the air intake manifold pressure 112 has been effectively maintained or held constant, and the exhaust manifold pressure has increased, the pressure differential across the engine 110 is increased, which as discussed above, results in an increase in the braking power of the compression brake. Further, because closing the intake throttle 122 and VGT components only slightly reduces the mass flow of air into the air intake manifold 112, the impact of the drop in air mass flow on the braking power is minimal.

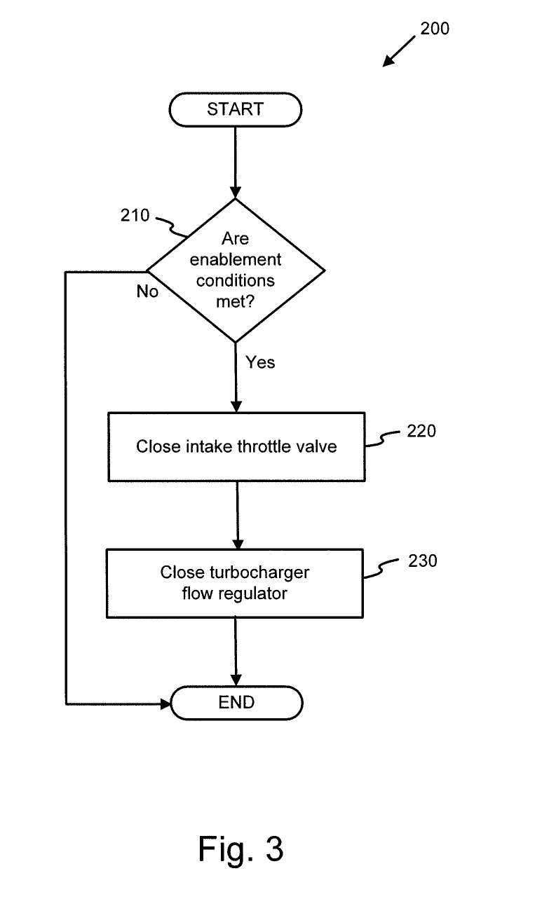

Referring to FIG. 3, a method 200 for increasing the braking power of a compression brake is shown and described. In some implementations, the method 200 is executed by the modules of the controller 120. The method 200 is run when the compression brake demand 154 indicates compression braking is activated and demanded (e.g., the compression brake 180 is being used to decelerate the engine 110). As shown, the method 200 begins by determining if the enablement conditions for activating braking power increase controls are met at 210. If the enablement conditions are not met at 210, then the method 200 ends. However, if the enablement conditions are met at 210, then the method 200 continues to close the intake throttle valve at 220 and close the VGT components of the turbocharger at 230. Although not shown, the method 200 may include modulating an EGR flow regulation device after closing the intake throttle valve and VGT components at 220, 230, respectively. Or, in yet another embodiment, such as with an engine system without an intake throttle, the method 200 may include modulating the EGR flow regulation device after closing just the VGT components. In the original embodiment, after the intake throttle valve and VGT components are closed, the method 200 ends. In some implementations, the method 200 is continuously run while compression braking is activated to fine-tune or adjust the position of the intake throttle valve and VGT components to better accommodate changing operating conditions of the engine system.

Although the system 100 and method 200 has been described in relation to a downsped engine in more particular embodiments, in other embodiments, the features and advantages of the system and method are equally applicable to any internal combustion engine system where enhanced compression braking is desirable and engine speeds may force compressor operation into a choke region of a compressor map. The choke region of a compressor map may be defined as a region that, for a given turbocharger speed, the compressor pressure ratio experiences a significant drop for a relatively small change in mass flow.

The described features, structures, advantages, and/or characteristics of the subject matter of the present disclosure may be combined in any suitable manner in one or more embodiments and/or implementations. In the above description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the above description and appended claims, or may be learned by the practice of the subject matter as set forth above.

In the above description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

The schematic flow chart diagrams and method schematic diagrams described above are generally set forth as logical flow chart diagrams. As such, the depicted order and labeled steps are indicative of representative embodiments. Other steps, orderings and methods may be conceived that are equivalent in function, logic, or effect to one or more steps, or portions thereof, of the methods illustrated in the schematic diagrams.

Additionally, the format and symbols employed are provided to explain the logical steps of the schematic diagrams and are understood not to limit the scope of the methods illustrated by the diagrams. Although various arrow types and line types may be employed in the schematic diagrams, they are understood not to limit the scope of the corresponding methods. Indeed, some arrows or other connectors may be used to indicate only the logical flow of a method. For instance, an arrow may indicate a waiting or monitoring period of unspecified duration between enumerated steps of a depicted method. Additionally, the order in which a particular method occurs may or may not strictly adhere to the order of the corresponding steps shown.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present subject matter may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An engine system, comprising:
an internal combustion engine including a compression brake;
a controller configured to:
determine whether the compression brake is being operated;
determine whether one or more enablement conditions are met; and
if the compression brake is being operated and the one or more enablement conditions are being met, implement an increase in braking power of the compression brake.

2. The engine system of claim 1, wherein the controller is configured to implement the increase in braking power of the compression brake by partially closing an air intake throttle communicatively connected to the engine and reducing a swallowing capacity of a turbine communicatively connected to the engine.

3. The engine system of claim 2, wherein the swallowing capacity of the turbine is decreased by partially closing a component of a variable geometry turbocharger.

4. The engine system of claim 2, wherein the swallowing capacity of the turbine is decreased by closing a wastegate flow regulation device.

5. The engine system of claim 2, wherein the controller is further configured to implement the increase in braking power of the compression brake by opening an exhaust gas recirculation regulator device communicatively associated with the engine.

6. The engine system of claim 1, wherein the one or more enablement conditions includes a turbocharger speed being less than a maximum turbocharger speed.

7. The engine system of claim 1, wherein the one or more enablement conditions includes an exhaust manifold pressure being less than a maximum exhaust manifold pressure.

8. The engine system of claim 1, wherein the one or more enablement conditions includes a compressor outlet temperature being less than a maximum compressor outlet temperature.

9. An engine system, comprising:
an internal combustion engine including a compression brake;
an air intake throttle operatively and communicatively coupled to the engine, the air intake throttle configured to permit air to travel to the engine;
a turbine operatively and communicatively coupled to the engine; and
a controller configured to, in response to operation of the compression brake and in further response to one or more enablement conditions being met, implement an increase in braking power of the compression brake by partially closing the air intake throttle and reducing a swallowing capacity of the turbine.

10. The engine system of claim 9, further comprising a variable geometry turbine component associated with the turbine, and wherein the swallowing capacity of the turbine is decreased by adjusting the variable geometry turbine component.

11. The engine system of claim 10, wherein the variable geometry turbine component is part of a variable geometry turbocharger.

12. The engine system of claim 10, wherein the variable geometry turbine component comprises a wastegate flow regulation device.

13. The engine system of claim 10, wherein the variable geometry turbocharger component is adjusted to maintain a speed of a compressor and increase in an exhaust manifold pressure.

14. The engine system of claim 10, further comprising an exhaust gas recirculation line configured to enable the recirculation of exhaust gas to the engine, the exhaust gas recirculation line including an exhaust gas recirculation regulator device, and wherein the controller is further configured to, if the one or more enablement conditions are met and the compression brake is being operated, implement the increase in braking power of the compression brake by opening the exhaust gas recirculation regulator device.

15. The engine system of claim 9, wherein the one or more enablement conditions includes a turbocharger speed being less than a maximum turbocharger speed.

16. The engine system of claim 9, wherein the one or more enablement conditions includes an exhaust manifold pressure being less than a maximum exhaust manifold pressure.

17. The engine system of claim 9, wherein the one or more enablement conditions includes a compressor outlet temperature being less than a maximum compressor outlet temperature.

18. A method for increasing braking power of a compression brake of an internal combustion engine, comprising:
determining whether the compression brake is being operated;
determining whether one or more enablement conditions are met; and
if it is determined that the compression brake is being operated and the one or more enablement conditions are being met, implement an increase in braking power of the compression brake by partially closing an air intake throttle communicatively connected to the internal combustion engine and reducing a swallowing capacity of a turbine associated with an internal combustion engine.

19. The method of claim 18, wherein the swallowing capacity of the turbine is decreased by partially closing a component of a variable geometry turbocharger.

20. The method of claim 18, wherein the swallowing capacity of the turbine is decreased by closing a wastegate flow regulation device.

21. The method of claim 18, wherein the increase in braking power of the compression brake is further implemented by opening an exhaust gas recirculation regulator device communicatively associated with the engine.

22. The method of claim 18, wherein the one or more enablement conditions includes a turbocharger speed being less than a maximum turbocharger speed.

23. The method of claim 18, wherein the one or more enablement conditions includes an exhaust manifold pressure being less than a maximum exhaust manifold pressure.

24. The method of claim 18, wherein the one or more enablement conditions includes a compressor outlet temperature being less than a maximum compressor outlet temperature.
